(19) United States
(12) Patent Application Publication
(10) Pub. No.: US 2024/0376006 A1
(43) Pub. Date: Nov. 14, 2024

(54) CEMENT COMPOSITION, FLUID LOSS CONTROL AGENT, AND FLUID LOSS CONTROL METHOD FOR CEMENT

(71) Applicant: Kuraray Co., Ltd., Okayama (JP)

(72) Inventors: Takuma KANESHIMA, Kurashiki-shi, Okayama (JP); JungYong KIM, Houston, TX (US); Ghebrehiwet GHEBREMESKEL, Houston, TX (US); Keisuke MORIKAWA, Kurashiki-shi, Okayama (JP)

(73) Assignee: Kuraray Co., Ltd., Okayama (JP)

(21) Appl. No.: 18/691,020

(22) PCT Filed: Sep. 9, 2022
(86) PCT No.: PCT/JP2022/033868

§ 371 Date: Mar. 11, 2024

Related U.S. Application Data
(60) Provisional application No. 63/243,299, filed on Sep. 13, 2021.

(51) Int. Cl. C04B 24/26; C04B 22/00; C04B 103/00; C04B 103/46

(52) U.S. Cl. CPC C04B 24/2623; C04B 22/0013; C04B 2103/0062; C04B 2103/465

(57) ABSTRACT

A cement composition containing a fluid loss control agent and a cement, wherein the fluid loss control agent contains a vinyl alcohol polymer and a crosslinking agent, and a swelling percentage of the fluid loss control agent is 200% or more and 3,600% or less.

### TECHNICAL FIELD

The present disclosure relates to a cement composition, a fluid loss control agent, and a fluid loss control method for a cement.

### BACKGROUND ART

Conventionally, in wells for extracting natural resource deposits such as petroleum and natural gas, a drilling cement slurry is known to be used. In well drilling, a gap (annulus) between a casing pipe and the well is filled with the drilling cement slurry, which is used for fixing the casing pipe. The cement slurry is injected through the casing pipe, then penetrates from the bottom of the well into the annulus, and is hardened. An inner wall of the well is protected by this step, which is referred to as “cementing”. A cement slurry suitable for such an operation has low viscosity, thereby enabling easy filling.

However, this method has still involved a problem of fluid loss, such as outflow of water contained in the cement slurry to porous geologic strata and/or rocks, due to contact of the pressurized cement slurry with a wall face of the well. When water in the cement slurry is lost by the fluid loss, viscosity of the slurry increases, leading to a decrease in fluidity, which may result in unsatisfactory packing of the cement. In addition, the outflow of water to the geologic strata can lead to collapse of the geologic strata. Furthermore, alteration of a water/cement ratio in the cement slurry can lead to insufficient hardening of the cement.

In order to solve the problem, using a polyvinyl alcohol based resin as a fluid loss control agent, which is capable of reducing fluid loss, for a cement slurry has been known.

Patent Document 1 (U.S. Pat. No. 4,967,839, specification) discloses a method in which a vinyl alcohol polymer having a degree of saponification of less than 92 mol % is used.

Patent Document 2 (U.S. Pat. No. 4,569,395, specification) discloses a method in which a vinyl alcohol polymer having a degree of saponification of more than 95 mol % is used.

Patent Document 3 (U.S. Pat. No. 7,815,731, specification) discloses a method in which two types of vinyl alcohol polymers both having a degree of saponification of 97% or more but having degrees of polymerization that differ from each other are concomitantly used.

Patent Document 4 (U.S. Pat. No. 10,550,038, specification) discloses a method in which a crosslinked product of a modified polyvinyl alcohol based resin is used.

Patent Document 5 (U.S. Pat. No. 6,739,806, specification) discloses a fluid loss control agent for a cement slurry in which two types of polymers are connected by a pH-sensitive crosslink.

### PRIOR ART DOCUMENTS

### Patent Documents

Patent Document 1: U.S. Pat. No. 4,967,839, specification

Patent Document 2: U.S. Pat. No. 4,569,395, specification

Patent Document 3: U.S. Pat. No. 7,815,731, specification

Patent Document 4: U.S. Pat. No. 10,550,038, specification

Patent Document 5: U.S. Pat. No. 6,739,806, specification

### SUMMARY OF THE INVENTION

### Problems to Be Solved by the Invention

An object of the present disclosure is to provide a cement composition, a fluid loss control agent, and a fluid loss control method for a cement which are superior in a capability of controlling fluid loss.

### Means for Solving the Problems

As a result of thorough investigation in order to solve the foregoing problems, the present inventors have found that a fluid loss control agent having a certain swelling percentage and a cement composition containing the same can solve the aforementioned problems, and accomplished the present invention.

More specifically, the present disclosure is directed to a cement composition containing a fluid loss control agent and a cement, wherein the fluid loss control agent contains a vinyl alcohol polymer and a crosslinking agent, and a swelling percentage of the fluid loss control agent is 200% or more and 3,600% or less.

The vinyl alcohol polymer and the crosslinking agent are preferably in a powder form.

A degree of saponification of the vinyl alcohol polymer is preferably 95 mol % or more.

The swelling percentage of the fluid loss control agent is preferably 300% or more and 1,000% or less.

It is preferable that: the vinyl alcohol polymer includes a vinyl alcohol unit and a constituent unit derived from an unsaturated monomer (A); the unsaturated monomer (A) is at least one selected from the group consisting of an unsaturated carboxylic acid, a salt thereof, an anhydride thereof, and an alkyl ester thereof; and a content of the constituent unit derived from the unsaturated monomer (A) with respect to total constituent units of the vinyl alcohol polymer is 1.0 mol % or more and 6.0 mol % or less.

The unsaturated monomer (A) is preferably at least one selected from the group consisting of methyl acrylate and methyl methacrylate.

An average degree of polymerization of the vinyl alcohol polymer is preferably 1,000 or more and 5,000 or less.

It is preferable that the vinyl alcohol polymer is a powder which has: at a content of 50 to 70% by mass, a particle size fraction consisting of powder particles being capable of passing through a sieve having a mesh opening size of 2.36 mm and being incapable of passing through a sieve having a mesh opening size of 0.15 mm; and at a content of 30 to 50% by mass, a particle size fraction consisting of powder particles being capable of passing through a sieve having a mesh opening size of 0.15 mm, the mesh opening sizes being defined in JIS Z 8801-1:2019.

The crosslinking agent is preferably a powder being capable of passing through a sieve having a mesh opening size of 2.36 mm, the mesh opening size being defined in JIS Z 8801-1:2019.

The crosslinking agent is preferably capable of forming a pH-sensitive crosslinked structure with the vinyl alcohol polymer.

The crosslinking agent is preferably a compound containing a group 13 element or a group 4 element.

The crosslinking agent is preferably a compound containing boron.

The crosslinking agent is preferably at least one selected from the group consisting of boric acid and sodium borate.

The crosslinking agent is preferably boric acid.

Furthermore, the present disclosure is also directed to a fluid loss control method for a cement, the fluid loss control method including mixing a liquid formulation with the cement composition.

Furthermore, the present disclosure is also directed to a fluid loss control agent containing a vinyl alcohol polymer and a crosslinking agent, wherein a swelling percentage of the fluid loss control agent is 200% or more and 3,600% or less.

It is preferred that in the fluid loss control agent, the vinyl alcohol polymer and the crosslinking agent are in a powder form.

Furthermore, the present disclosure is also directed to a fluid loss control method including mixing a cement with the fluid loss control agent.

### Effects of the Invention

The present disclosure enables providing a cement composition and a fluid loss control agent which are superior in a capability of controlling fluid loss. Furthermore, the fluid loss control method for a cement of the present disclosure is superior in a fluid loss control effect.

### DESCRIPTION OF EMBODIMENTS

Hereinafter, the present invention will be described in detail, but exemplary embodiments are merely demonstrated thereby, and the present invention should not be construed to be limited thereto. Vinyl Alcohol Polymer

The vinyl alcohol polymer of the present disclosure includes a vinyl alcohol unit. The vinyl alcohol unit may be derived from a vinyl ester unit by hydrolysis, alcoholysis, or the like. Therefore, depending upon conditions and the like in converting from the vinyl ester unit to the vinyl alcohol unit, the vinyl ester unit may remain in the vinyl alcohol polymer. Thus, the vinyl alcohol polymer of the present disclosure may include the vinyl ester unit.

The vinyl ester unit is a constituent unit derived from a vinyl ester monomer. Examples of the vinyl ester monomer include vinyl acetate, vinyl formate, vinyl propionate, vinyl caprylate, vinyl versatate, and the like. Of these, from an industrial perspective, vinyl acetate is preferred.

A degree of saponification of the vinyl alcohol polymer of the present disclosure is preferably 95 mol % or more, more preferably 99 mol % or more, and may be still more preferably 99.5 mol % or more. Furthermore, the degree of saponification of the vinyl alcohol polymer may be 100 mol % or less, or may be 99.99 mol % or less. When the degree of saponification falls within the above range, the capability of controlling fluid loss at a high temperature tends to be more superior. The degree of saponification of the vinyl alcohol polymer of the present disclosure is measured by ¹H -NMR.

Viscosity of a 4% aqueous solution of the vinyl alcohol polymer at 20° C. as determined in accordance with JIS K 6726:1994 is preferably 15 mPa·s or more and 130 mPa·s or less, more preferably 16 mPa·s or more and 120 mPa·s or less, still more preferably 17 mPa·s or more and 110 mPa·s or less, and may be yet more preferably 17 mPa·s or more and 100 mPa·s or less. When the viscosity of the 4% aqueous solution at 20° C. falls within the above range, the fluid loss control effect may be more superior, and production tends to be further facilitated.

The average degree of polymerization of the vinyl alcohol polymer is preferably 1,000 or more and 5,000 or less, more preferably 1,100 or more and 4,000 or less, and may be still more preferably 1,200 or more and 2,000 or less. When the average degree of polymerization falls within the above range, the fluid loss control effect may be more superior, and production tends to be further facilitated. It is to be noted that the average degree of polymerization of the vinyl alcohol polymer of the present disclosure is an average degree of polymerization determined in accordance with JIS K 6726-1994.

A form of the vinyl alcohol polymer is not particularly limited, but is preferably a powder. The powder of the vinyl alcohol polymer is preferably a powder which has: at a content of 50 to 70% by mass, a particle size fraction consisting of powder particles being capable of passing through a sieve having a mesh opening size of 2.36 mm and being incapable of passing through a sieve having a mesh opening size of 0.15 mm; and at a content of 30 to 50% by mass, a particle size fraction consisting of powder particles being capable of passing through a sieve having a mesh opening size of 0.15 mm, the mesh opening sizes being defined in JIS Z 8801-1:2019. When the particle diameter of the powder falls within the above range, dispersibility in a cement slurry tends to be more favorable. The powder of the vinyl alcohol polymer is also preferably a powder being capable of passing through a sieve having a mesh opening size of 2.36 mm, the mesh opening size being defined in JIS Z 8801-1:2019.

A method for producing the vinyl alcohol polymer of the present disclosure is not particularly limited. For example, a method including: polymerizing the vinyl ester monomer; and saponifying a vinyl ester polymer thus obtained, i.e., carrying out hydrolysis or alcoholysis, to obtain a vinyl alcohol polymer is convenient and preferably employed.

A polymerization system for polymerizing the vinyl ester monomer may involve any one of batchwise polymerization, semi-batchwise polymerization, continuous polymerization, semi-continuous polymerization, and the like, and as a polymerization procedure, a well-known process such as a bulk polymerization process, a solution polymerization process, a suspension polymerization process, or an emulsion polymerization process may be adopted. The bulk polymerization process or the solution polymerization process, in each of which polymerization is allowed to proceed in the absence of a solvent or in a solvent such as an alcohol, is preferred. In a case in which a vinyl ester polymer having a high degree of polymerization is to be obtained, employing the emulsion polymerization process may be one option. The solvent for use in the solution polymerization process is not particularly limited and may be, for example, an alcohol. The alcohol which may be used as the solvent for the solution polymerization process may be, for example, a lower alcohol such as methanol, ethanol, or propanol. The amount of the solvent used in the polymerization system may be selected taking into consideration chain transfer of the solvent, depending on the average degree of polymerization of the vinyl alcohol polymer intended. For example, in the case in which the solvent is methanol, a mass ratio {=(solvent)/(total monomers)}, being a ratio of the solvent to total monomers contained in the polymerization system, falls within a range of preferably from 0.01 to 10, and may be more preferably from 0.05 to 3.

A polymerization initiator used in the polymerization of the vinyl ester monomer is not particularly limited and may be selected from well-known polymerization initiators such as, e.g., an azo type initiator, a peroxide type initiator, a redox type initiator, and the like, depending on the polymerization procedure. Examples of the azo type initiator include 2,2′-azobisisobutyronitrile, 2,2′-azobis(2,4-dimethylvaleronitrile), and 2,2′-azobis(4-methoxy-2,4-dimethylvaleronitrile). Examples of the peroxide type initiator include: percarbonate-based compounds such as diisopropyl peroxydicarbonate, di-2-ethylhexyl peroxydicarbonate, and diethoxyethyl peroxydicarbonate; perester compounds such as t-butyl peroxyneodecanate and α-cumyl peroxyneodecanate; acetylcyclohexylsulfonyl peroxide; 2,4,4-trimethylpentyl 2-peroxyphenoxyacetate; and the like. As the polymerization initiator, potassium persulfate, ammonium persulfate, hydrogen peroxide, or the like may be used in combination with the initiator described above. The redox type initiator is a polymerization initiator prepared by combining, for example, the peroxide type initiator with a reducing agent such as sodium bisulfite, sodium bicarbonate, tartaric acid, L-ascorbic acid, or Rongalit. Although the amount of the polymerization initiator used is not generally predetermined since the amount may vary depending on the polymerization catalyst, the amount may be selected depending on a polymerization rate and the like. For example, in the case in which azobisisobutyronitrile or acetyl peroxide is used as the polymerization initiator, the amount with respect to the vinyl ester monomer is preferably 0.01 mol % or more and 0.2 mol % or less, and may be more preferably 0.02 mol % or more and 0.15 mol % or less. The polymerization temperature is not particularly limited, and may be around room temperature or higher and about 150° C. or lower, and is preferably 40° C. or higher and a boiling point of the solvent used or lower.

The polymerization of the vinyl ester monomer may be carried out in the presence of a chain transfer agent as long as the effects of the present disclosure can be achieved. Examples of the chain transfer agent include: aldehydes such as acetaldehyde and propionaldehyde; ketones such as acetone and methyl ethyl ketone; mercaptans such as 2-hydroxyethanethiol; phosphinic acid salts such as sodium phosphinate monohydrate; and the like. In particular, aldehydes and ketones may be suitably used. The amount of the chain transfer agent added to the polymerization system may be predetermined depending on the chain transfer coefficient of the chain transfer agent to be added, and the degree of polymerization of the vinyl alcohol polymer intended, and the amount of the chain transfer agent with respect to 100 parts by mass of the vinyl ester monomer is preferably 0.1 parts by mass or more and 10 parts by mass or less.

Saponification of the vinyl ester polymer is conducted in a state of the polymer being dissolved in an alcohol or hydrous alcohol, for example. The alcohol which may be used in the saponification is, for example, a lower alcohol such as methanol or ethanol, and is preferably methanol. The alcohol which may be used in the saponification may contain, a solvent such as acetone, methyl acetate, ethyl acetate, or benzene as long as a mass thereof is, for example, 40% by mass or less. A catalyst for use in the saponification is exemplified by an alkali metal hydroxide such as potassium hydroxide or sodium hydroxide, an alkali catalyst such as sodium methylate, and an acid catalyst such as a mineral acid. A temperature at which the saponification is conducted is not limited, and suitably falls within a range of 20° C. or higher and 60° C. or lower. In a case in which a gelatinous product emerges to deposit as the saponification proceeds, the product may be pulverized and then washed and dried to enable giving the vinyl alcohol polymer. The saponification process is not limited to those described above, and any of well-known methods can be adopted.

In the present disclosure, when the vinyl alcohol polymer is in a powder form, a procedure for adjusting the particle diameter to fall within the above range is exemplified by: a process of grinding particles of the vinyl alcohol polymer with a grinding machine; a process (slurry saponification process) of conducting saponification of the vinyl ester polymer in a slurry state in a large excess amount of an alcohol solution; and the like. Of these, the slurry saponification process is preferably employed since the powder of the vinyl alcohol polymer having the particle diameter intended can be obtained, without need of carrying out a grinding step.

As one embodiment of the method for producing a vinyl alcohol polymer, a production method including: a polymerizing step of polymerizing a vinyl ester monomer to obtain a vinyl ester polymer; and a saponifying step of saponifying the vinyl ester polymer in a slurry state to obtain a vinyl alcohol polymer is preferred.

The vinyl alcohol polymer of the present disclosure may include, in addition to the vinyl alcohol unit, a constituent unit derived from an unsaturated monomer (A). The unsaturated monomer (A) is at least one selected from the group consisting of an unsaturated carboxylic acid, a salt thereof, an anhydride thereof, and an alkyl ester thereof. The unsaturated monomer (A) is exemplified by unsaturated monomers which are copolymerizable with the vinyl ester monomer, and examples thereof include maleic acid, maleic anhydride, itaconic acid, acrylic acid, methacrylic acid, salts thereof, anhydrides thereof, alkyl esters thereof, and the like. Of these, in light of production, methyl acrylate and methyl methacrylate are preferred.

A content of the constituent unit derived from the unsaturated monomer (A) in the vinyl alcohol polymer of the present disclosure with respect to the total constituent units of the vinyl alcohol polymer is preferably 1.0 mol % or more and 6.0 mol % or less, and may be more preferably 1.5 mol % or more and 5.5 mol % or less. When the content falls within the above range, a swelling property in the cement slurry can increase and the fluid loss control effect can be more superior. The vinyl alcohol polymer of the present disclosure may have one, or two or more types of the constituent unit derived from the unsaturated monomer (A). In the case of having two or more types of the constituent unit, a total of contents of these two or more types of the constituent unit preferably falls within the above range. It is to be noted that as referred to in the present disclosure, the constituent unit in the polymer means a repeating unit constituting the polymer. For example, the constituent unit may be the vinyl alcohol unit as well as the vinyl ester unit.

The vinyl alcohol polymer of the present disclosure may further have a constituent unit other than the vinyl alcohol unit, the constituent unit derived from the unsaturated monomer (A), and the vinyl ester unit, as long as the effects of the present disclosure are achieved. The constituent unit is, for example, a structural constituent unit derived from an ethylenic unsaturated monomer which is copolymerizable with the unsaturated monomer (A) and the vinyl ester monomer. Examples of the ethylenic unsaturated monomer include: α-olefins such as ethylene, propylene, n-butene, and isobutylene; acrylamide derivatives such as acrylamide, N-methylacrylamide, N-ethylacrylamide, N,N-dimethylacrylamide, diacetoneacrylamide, acrylamidepropane sulfonic acid and salts thereof, acrylamidepropyldimethylamine and salts thereof or quatemary salts thereof, and N-methylolacrylamide and derivatives of the same; methacrylamide derivatives such as methacrylamide, N-methylmethacrylamide, N-ethylmethacrylamide, methacrylamidepropane sulfonic acid and salts thereof, methacrylamidepropyldimethylamine and salts thereof or quaternary salts thereof, and N-methylolmethacrylamide and derivatives of the same; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; vinyl halides such as vinyl chloride and vinyl fluoride; vinylidene halides such as vinylidene chloride and vinylidene fluoride; ally compounds such as allyl acetate and ally chloride; vinylsilyl compounds such as vinyltrimethoxysilane; oxyalkylene group-containing monomers such as polyoxyethylene (meth)acrylate, polyoxypropylene (meth)acrylate, polyoxyethyleneamide (meth)acrylate, polyoxypropyleneamide (meth)acrylate, polyoxyethylene (1-(meth)acrylamide-1,1-dimethylpropyl) ester, polyoxyethylene (meth)allyl ether, polyoxypropylene (meth)allyl ether, polyoxyethylenevinyl ether, and polyoxypropylenevinyl ether; isopropenyl acetate; and the like. A content of the constituent unit other than the vinyl alcohol unit, the constituent unit derived from the unsaturated monomer (A), and the vinyl ester unit is, with respect to the total constituent units of the vinyl alcohol polymer, preferably 10 mol % or less, more preferably 5 mol % or less, still more preferably 2 mol % or less, and may be even more preferably 0 mol %, i.e., not substantially including the constituent unit other than the vinyl alcohol unit, the constituent unit derived from the unsaturated monomer (A), and the vinyl ester unit.

The order of alignment of the vinyl alcohol unit, the constituent unit derived from the unsaturated monomer (A), and other optional constituent unit(s) in the vinyl alcohol polymer of the present disclosure is not particularly limited, and may be any of random, block, alternate, or the like.

### Fluid Loss Control Agent

The fluid loss control agent of the present disclosure contains a vinyl alcohol polymer and a crosslinking agent, and a swelling percentage of the fluid loss control agent is 200% or more and 3,600% or less. The fluid loss control agent of the present disclosure is suitably used for a cement.

The swelling percentage as referred to in the present disclosure means a swelling percentage in a case of charging 2 g of the fluid loss control agent into 98 g of a saturated aqueous solution of calcium hydroxide, heating the solution to 95° C. under stirring, and then, following the elapse of 15 min, cooling to room temperature, and is specifically measured as described below.

More specifically, 98 g of the saturated aqueous solution of calcium hydroxide is charged into a 200 mL beaker, 2 g of the fluid loss control agent is added thereto while stirring at 600 rpm using a magnetic stirrer with hot plate, the mixture is heated to 95° C., and then stirring is performed for an additional 15 min. This mixture is cooled to room temperature, and then a part of a gelatinous matter thus obtained is sampled, and a mass a before drying (g) and a mass b after drying (g) are measured. Furthermore, separately from this, a solid content percentage c (%) of the fluid loss control agent is measured by a common procedure, and the swelling percentage (%) is calculated in accordance with the following equation

$$swelling percentage ( \% ) = \{ ( a - b \times 10 \; 0 / c ) / ( b \times 100 / c ) \} \times 100$$

As the vinyl alcohol polymer contained in the fluid loss control agent, the above-described vinyl alcohol polymer can be suitably used.

The crosslinking agent is preferably a crosslinking agent which is capable of forming a pH-sensitive crosslinked structure with the vinyl alcohol polymer. The crosslinking agent is preferably a compound containing a group 13 element such as boron or aluminum or a group 4 element such as titanium or zirconium, more preferably a compound containing boron, still more preferably boric acid or sodium borate, and may be particularly preferably boric acid. Furthermore, as sodium borate, borax may be preferred. The crosslinking agent may be one type, or may be a combination of two or more types of compounds. For example, the above-described crosslinking agent is a crosslinking agent which is capable of forming a pH-sensitive crosslinked structure with the vinyl alcohol polymer.

A form of the crosslinking agent is preferably a powder form. The crosslinking agent in the powder form is preferably a powder being capable of passing through a sieve having a mesh opening size of 2.36 mm, and may be more preferably a powder being capable of passing through a sieve having a mesh opening size of 1 mm, the mesh opening sizes being defined in JIS Z 8801-1:2019. When the particle diameter of the powder falls within the above range, dispersibility in the cement composition tends to be more favorable.

The swelling percentage of the fluid loss control agent of the present disclosure is 200% or more and 3,600% or less, and is preferably 300% or more and 1,000% or less, and may be more preferably 400% or more and 600% or less. When the swelling percentage falls within the above range, the fluid loss control effect tends to be more superior. For example, by appropriately setting the amount of the crosslinking agent, the swelling percentage can be controlled to fall within the above range. More specifically, when the content of the crosslinking agent is increased within an appropriate range, the swelling percentage tends to decrease. Furthermore, when the vinyl alcohol polymer containing the constituent unit derived from the unsaturated monomer (A) at a high content is used, the swelling percentage tends to increase. However, the swelling percentage is not decided by only the content of the crosslinking agent and the content of the constituent unit derived from the unsaturated monomer (A); the swelling percentage can also be adjusted by other conditions. For example, the degree of saponification of the vinyl alcohol polymer, the particle diameters of the vinyl alcohol polymer and the crosslinking agent, and the like also influence the swelling percentage. For example, in a case in which the other conditions are the same, using a vinyl alcohol polymer having a somewhat low degree of saponification (for example, a vinyl alcohol polymer having a degree of saponification of about 99 mol %, and specifically a vinyl alcohol polymer having a degree of saponification of 97.5 mol % or more and 99.5 mol % or less) tends to increase the swelling percentage more than using a vinyl alcohol polymer which has been completely saponified.

The amount of the crosslinking agent with respect to the vinyl alcohol polymer in the fluid loss control agent is not particularly limited and can be appropriately set in accordance with, for example, types, modification amounts, and the like of the constituent units of the vinyl alcohol polymer, and the amount is, for example, preferably 1% by mass or more and 50% by mass or less, and may be more preferably 2% by mass or more and 30% by mass or less. When the amount of the crosslinking agent falls within the above range, the fluid loss control effect tends to be more superior. It is to be noted that the amount of the crosslinking agent (% by mass) is an amount with respect to the vinyl alcohol polymer (100% by mass). Furthermore, for example, in the case in which the vinyl alcohol polymer includes the constituent unit derived from the unsaturated monomer (A), the amount of the crosslinking agent is preferably 3% by mass or more and 30% by mass or less, and more preferably 5% by mass or more and 25% by mass or less. In the case in which the vinyl alcohol polymer is an unmodified vinyl alcohol polymer, the amount of the crosslinking agent is preferably 1.5% by mass or more and 2.7% by mass or less, and more preferably 2.0% by mass or more and 2.6% by mass or less.

The fluid loss control agent in the present disclosure may further contain component(s) other than the vinyl alcohol polymer and the crosslinking agent. Examples of the other component(s) include: polymerization regulators such as aldehydes, halogenated hydrocarbons, and mercaptans; polymerization inhibitors such as phenol compounds, sulfur compounds, and N-oxide compounds; pH adjusting agents; antiseptic agents; mildew-proofing agents; antiblocking agents; defoaming agents; compatibility accelerators; and the like. In the case in which the vinyl alcohol polymer and the crosslinking agent are in the powder form, the other component(s) may be contained in these powders.

However, the fluid loss control agent of the present disclosure is preferably constituted from substantially only the vinyl alcohol polymer and the crosslinking agent. A total content of the vinyl alcohol polymer and the crosslinking agent in the fluid loss control agent of the present disclosure is preferably 90% by mass or more, and more preferably 99% by mass or more. In such a case, the fluid loss control effect tends to be more superior.

As described later, the fluid loss control agent in the present disclosure exhibits the fluid loss control effect when a cement and a liquid formulation are mixed therewith to give a cement slurry. In a stage before mixing the fluid loss control agent with the cement and the liquid formulation, it is preferred that the vinyl alcohol polymer and the crosslinking agent in the fluid loss control agent are present in a state without substantially forming a crosslinked structure. Since such a fluid loss control agent forms the crosslinked structure in the cement slurry system to exhibit the fluid loss control effect, it is not necessary to, for example, permit the vinyl alcohol polymer and the crosslinking agent to react beforehand, thereby synthesizing a crosslinked product, and to further form this crosslinked product into a powder and add this powder to the cement slurry. Thus, the fluid loss control agent of the present disclosure and the cement composition of the present disclosure, described later, are superior in production efficiency and handleability. In other words, one preferred embodiment of the fluid loss control agent of the present disclosure is a mixed powder of a powder of the vinyl alcohol polymer and a powder of the crosslinking agent.

### Cement Composition

The cement composition of the present disclosure contains a fluid loss control agent and a cement, wherein the fluid loss control agent contains a vinyl alcohol polymer and a crosslinking agent, and a swelling percentage of the fluid loss control agent is 200% or more and 3,600% or less. The cement composition does not necessarily contain a liquid formulation, and furthermore, may be in a powder form. In such a case, in the cement composition, the vinyl alcohol polymer and the crosslinking agent are preferably present in a state without substantially forming a crosslinked structure. As described later, the cement composition forms a crosslinked structure when mixed with the liquid formulation to give a cement slurry, and can exhibit a superior fluid loss control effect.

As the fluid loss control agent in the cement composition, the above-described fluid loss control agent can be suitably used.

The cement composition is mixed with the liquid formulation and used as the cement slurry. One preferred embodiment of the cement slurry is a cement slurry containing the liquid formulation, other additive component(s), and the cement composition of the present disclosure. In the cement slurry, a component derived from the fluid loss control agent forms a crosslinked structure, whereby the fluid loss control effect is exhibited when the cement slurry is used.

A content of the fluid loss control agent in the cement composition (for example, a sum of the contents of the vinyl alcohol polymer and the crosslinking agent) with respect to 100 parts by mass of the cement is preferably 0.1 parts by mass or more and 5 parts by mass or less, more preferably 0.2 parts by mass or more and 3 parts by mass or less, and may be still more preferably 0.3 parts by mass or more and 1.5 parts by mass or less. When the content of the fluid loss control agent falls within the above range, the fluid loss control effect can be more superior, and the viscosity of the cement slurry can be more favorable.

The liquid formulation is predetermined depending on the type of the cement and the like, and is exemplified by: water; a solvent; and a mixture of these, and water is preferred. The content of the liquid formulation in the cement slurry is, with respect to 100 parts by mass of the cement, preferably 30 parts by mass or more and 60 parts by mass or less, more preferably 33 parts by mass or more and 55 parts by mass or less, and may be still more preferably 35 parts by mass or more and 50 parts by mass or less. Further, it is preferred that the liquid formulation is water, and that the content of water falls within the above range. When the content of the liquid formulation falls within the above range, strength of the cured matter can be more favorable, and the viscosity of the cement slurry can be more favorable.

The cement is exemplified by Portland cement, a mixed cement, an eco-cement, a special cement, and the like. In particular, in drilling applications, a geothermal-well cement and an oil-well cement may be preferably employed. These cements are defined by the American Petroleum Institute as classes A to H standards, and cements of classes G and H are preferred.

The other additive component which may be added to the cement slurry is exemplified by a dispersant, a retarder, an accelerator, a low-density additive, a high-density additive, a strength stabilizer, a washing agent, a defoaming agent, a crosslinking agent other than the one described above, a scale inhibitor, a water loss inhibitor, and the like. These additive components may be added as needed, taking into consideration the composition, and either one type or multiple types thereof may be used.

In the present disclosure, by using such a cement composition, a more superior fluid loss control effect can be achieved.

It is to be noted that in producing the cement composition of the present disclosure, a sequence of mixing the components of the cement composition is not particularly limited. For example, in the case of the cement composition containing the vinyl alcohol polymer, the crosslinking agent, and the cement, the sequence of mixing these components may be in any order. For example, a formulation resulting from mixing the vinyl alcohol polymer with the crosslinking agent beforehand may be added to the cement; for example, the vinyl alcohol polymer may be added to the cement, followed by adding the crosslinking agent thereto; or for example, the vinyl alcohol polymer, the crosslinking agent, and the cement may be mixed simultaneously.

As referred to in the present disclosure, the fluid loss control agent in the cement composition means a component resulting from combining the vinyl alcohol polymer in the cement composition with the crosslinking agent. With regard to the swelling percentage of the fluid loss control agent in the cement composition, for example, a swelling percentage of the fluid loss control agent before blending into the cement composition may be measured; or, for example, a fluid loss control agent being the same as the fluid loss control agent contained in the cement composition may be prepared separately, and the swelling percentage thereof may be measured. More specifically, the swelling percentage of a mixture resulting from separately mixing the crosslinking agent with the same vinyl alcohol polymer as that contained in the cement composition, at the blending proportion at which these are contained in the cement composition, may be adopted as the swelling percentage of the fluid loss control agent in the cement composition.

### Fluid Loss Control Method for Cement

One embodiment of the present disclosure is a fluid loss control method for a cement, the fluid loss control method including a step of mixing a cement with the fluid loss control agent. It is to be noted that the fluid loss control method for a cement of the present disclosure is acceptable as long as fluid loss can be controlled, and is not limited to a method in which fluid loss is completely prevented.

In the fluid loss control method for a cement of the present disclosure, the components of the fluid loss control agent may be simultaneously mixed with the cement, or the components of the fluid loss control agent may be separately added and mixed. For example, the fluid loss control agent, prepared by mixing the vinyl alcohol polymer with the crosslinking agent beforehand, may be added to the cement; or for example, the vinyl alcohol polymer may be added to the cement, followed by adding the crosslinking agent thereto.

Another embodiment of the present disclosure is a fluid loss control method for a cement, the fluid loss control method including mixing a liquid formulation with the cement composition. The mixing of the liquid formulation with the cement composition may be conducted according to a common procedure, and for example, the cement slurry may be produced by mixing the liquid formulation, the cement composition of the present disclosure, and as needed, the other additive component(s).

In the fluid loss control method for a cement of the present disclosure, an order of mixing each component is not limited, and for example, the components of the cement composition may be simultaneously mixed with the liquid formulation, or the components of the cement composition may be separately added and mixed. For example, the cement composition, prepared by mixing the vinyl alcohol polymer, the crosslinking agent, and the cement beforehand, may be added to the liquid formulation; for example, the cement may be added to the liquid formulation, followed by adding thereto the vinyl alcohol polymer and then the crosslinking agent; or, for example, the liquid formulation may be added to the cement composition.

The cement composition of the present disclosure can be suitably used for a drilling cement slurry to be used in drilling porous geologic strata, rocks, and the like.

### EXAMPLES

Hereinafter, the present invention is specifically explained by way of Examples, but the present invention is not in any way limited thereto. It is to be noted that in Examples, “part(s)”, or “%” means on mass basis, unless otherwise specified particularly.

### Average Degree of Polymerization of Vinyl Alcohol Polymer

The average degree of polymerization of the vinyl alcohol polymer was determined in accordance with HS K 6726-1994.

### Viscosity of 4% by Mass Aqueous Solution of Vinyl Alcohol Polymer at 20° C.

The viscosity (mPa·s) of a 4% by mass aqueous solution of the vinyl alcohol polymer at 20° C. was measured by using the B-type viscometer BLIT (manufactured by Toki Sangyo Co., Ltd) under a condition involving: a rotor speed of 60 rpm, and a temperature of 20° C.

### Degree of Saponification of Vinyl Alcohol Polymer

The degree of saponification of the vinyl alcohol polymer (mol %) was determined by ¹ H-NMR.

### Content (Modification Amount) of Constituent Unit Derived From Unsaturated Monomer (A)

The content (mol %; modification amount) of the constituent unit derived from the unsaturated monomer (A) in the vinyl alcohol polymer was determined by 1 1H-NMR.

### Production Example 1

(1) Into a reactor equipped with a stirrer, a reflux condenser, an argon inlet tube, an addition port for the unsaturated monomer (A) (comonomer), and an addition port for the polymerization initiator were charged 1,392 parts by mass of vinyl acetate, 2.42 parts by mass of methyl acrylate as a comonomer, and 655 parts by mass of methanol, and replacement with argon in the system was carried out for 30 min while argon was bubbled. Separately therefrom, as a successively added solution of the comonomer (hereinafter, referred to as “delay solution”), a methanol solution of methyl acrylate (concentration: 20% by mass) was prepared, and argon was bubbled thereinto for 30 min. Temperature elevation of the reactor was started, and when the internal temperature became 60° C., 0.4 parts by mass of 2,2′-azobisisobutyronitrile (AIBN) were added to initiate polymerization. While the polymerization reaction proceeded, the delay solution which had been prepared was added dropwise into the system, whereby the monomer composition (molar ratio of methyl acrylate to vinyl acetate) in the polymerization solution was maintained constant. After allowing for the polymerization at 60° C. for 3.8 hrs, the polymerization was terminated by cooling. When the polymerization was terminated, the conversion (rate of polymerization) was 40%. Subsequently, unreacted monomer was eliminated while methanol was added at intervals at 30° C. under a reduced pressure to give a methanol solution of polyvinyl acetate (concentration: 35%) into which methyl acrylate had been introduced.

(2) Polyvinyl acetate, which was obtained in (1) above, into which methyl acrylate had been introduced, was used to prepare a 33% methanol solution, and this solution was added into a reaction chamber, and thereto was added a methanol solution of anhydrous sodium methylate such that a molar ratio of sodium methylate to the vinyl acetate unit in polyvinyl acetate into which methyl acrylate had been introduced became 0.008. The reaction chamber was heated while stirring the solution, and maintained at a boiling point to conduct the saponification reaction, whereby a saponification product was obtained in a slurry state. The saponification product thus obtained was removed from the reaction chamber, and immersed in a 0.1% acetic acid methanol solution for 1 hour such that a percentage of the solid content became 20%. After washing, the saponification product was heat-treated at 120° C. for 9 min. The slurry liquid was cooled, and next, in a solid-liquid separation step, was separated into a solution and a wet cake of the vinyl alcohol polymer. Thereafter, only the wet cake was retrieved, and was subjected to a drying treatment, whereby a vinyl alcohol polymer (PVA-1) being aggregates of particulate powder was obtained. PVA-1 contained: at a content of 62% by mass, a particle size fraction consisting of powder particles being capable of passing through a sieve having a mesh opening size of 2.36 mm and being incapable of passing through a sieve having a mesh opening size of 0.15 mm; and at a content of 38% by mass, a particle size fraction consisting of powder particles being capable of passing through a sieve having a mesh opening size of 0.15 mm, the mesh opening sizes being defined in JIS Z 8801-1:2019. With respect to PVA-1 thus obtained, the polymerization and saponification conditions, the average degree of polymerization, the degree of saponification, the viscosity of a 4% aqueous solution at 20° C., and the content (modification amount) of the constituent unit derived from the unsaturated monomer (A) are shown in Table 1 and Table 2.

### Production Example 2

(1) A methanol solution of polyvinyl acetate (concentration: 25%) into which methyl methacrylate had been introduced was obtained by a similar operation to that of Production Example 1, except that various conditions such as the charging amounts of vinyl acetate and methanol, the amount of addition of AIBN, and the type and the amount of addition of the unsaturated monomer (A) were charged as shown in Table 1.

(2) To a saponification ingredient liquid prepared so as to adjust the concentration to be 20% by adding methanol to the methanol solution of polyvinyl acetate, which was obtained in (1) above, into which methyl methacrylate had been introduced, a methanol solution of sodium hydroxide was further added such that a molar ratio of sodium hydroxide to vinyl acetate unit in polyvinyl acetate, into which methyl acrylate had been introduced, became 0.04, and saponification was conducted at room temperature. Since a gelatinous matter of the vinyl alcohol polymer was produced in about 20 min after adding the methanol solution of sodium hydroxide, the gelatinous matter was ground with a grinding machine. Furthermore, the methanol solution of sodium hydroxide was added such that a molar ratio of sodium hydroxide to the monomer unit in the vinyl alcohol polymer became 0.02, and the saponification was allowed to proceed by leaving a resulting mixture to stand at 40° C. for 2 hrs. The product was immersed in a 0.1% acetic acid methanol solution for 1 hour such that a percentage of the solid content became 20% and washed, and thereafter dried at 70° C. for 12 hrs. The dried matter was ground with a grinding machine, whereby a vinyl alcohol polymer (PVA-2) was obtained. PVA-2 contained: at a content of 59% by mass, a particle size fraction consisting of powder particles being capable of passing through a sieve having a mesh opening size of 2.36 mm and being incapable of passing through a sieve having a mesh opening size of 0.15 mm; and at a content of 41% by mass, a particle size fraction consisting of powder particles being capable of passing through a sieve having a mesh opening size of 0.15 mm, the mesh opening sizes being defined in JIS Z 8801-1:2019. With respect to PVA-2 thus obtained, the polymerization and saponification conditions, the average degree of polymerization, the degree of saponification, the viscosity of a 4% aqueous solution at 20° C., and the content (modification amount) of the constituent unit derived from the unsaturated monomer (A) are shown in Table 1 and Table 2.

### Production Example 3

A vinyl alcohol polymer (PVA-3) was obtained by a similar operation to that of Production Example 2, except that various conditions such as the charging amounts of vinyl acetate and methanol, the amount of addition of AIBN, and the type and the amount of addition of the unsaturated monomer (A) were charged as shown in Table 1. PVA-3 contained: at a content of 63% by mass, a particle size fraction consisting of powder particles being capable of passing through a sieve having a mesh opening size of 2.36 mm and being incapable of passing through a sieve having a mesh opening size of 0.15 mm; and at a content of 37% by mass, a particle size fraction consisting of powder particles being capable of passing through a sieve having a mesh opening size of 0.15 mm, the mesh opening sizes being defined in JIS Z 8801-1:2019. With respect to PVA-3 thus obtained, the polymerization and saponification conditions, the average degree of polymerization, the degree of saponification, the viscosity of a 4% aqueous solution at 20° C., and the content (modification amount) of the constituent unit derived from the unsaturated monomer (A) are shown in Table 1 and Table 2.

### Production Examples 4 to 6

Vinyl alcohol polymers (PVA-4 to PVA-6) were each obtained by a similar operation to that of Production Example 3, except that various conditions such as the amount of addition of methanol, and the saponification conditions were changed as shown in Tables 1 and 2. PVA-4 to PVA-6 passed through a sieve having a mesh opening size of 2.36 mm, the mesh opening size being defined in JIS Z 8801-1:2019. PVA-4 contained: at a content of 62% by mass, a particle size fraction consisting of powder particles being incapable of passing through a sieve having a mesh opening size of 0.15 mm; and at a content of 38% by mass, a particle size fraction consisting of powder particles being capable of passing through a sieve having a mesh opening size of 0.15 mm. PVA-5 contained: at a content of 61% by mass, a particle size fraction consisting of powder particles being incapable of passing through a sieve having a mesh opening size of 0.15 mm; and at a content of 39% by mass, a particle size fraction consisting of powder particles being capable of passing through a sieve having a mesh opening size of 0.15 mm. PVA-6 contained: at a content of 66% by mass, a particle size fraction consisting of powder particles being incapable of passing through a sieve having a mesh opening size of 0.15 mm; and at a content of 34% by mass, a particle size fraction consisting of powder particles being capable of passing through a sieve having a mesh opening size of 0.15 mm. With respect to PVA-4 to PVA-6 thus obtained, the polymerization and saponification conditions, the average degree of polymerization, the degree of saponification, and the viscosity of a 4% aqueous solution at 20° C. are shown in Table 1 and Table 2.

TABLE 1

| | Type of vinyl | Components used for polymerization | | | | | Con- |
|---|---|---|---|---|---|---|---|
| | alcohol | vinyl acetate | methanol | AIBN | unsaturated monomer (A) | | version |
| | polymer | (parts by mass) | (parts by mass) | (parts by mass) | (type) | (parts by mass) | (%) |
| Production Example 1 | PVA-1 | 1,392 | 655 | 0.4 | methyl acrylate | 2.42 | 40 |
| Production Example 2 | PVA-2 | 1,392 | 559 | 0.4 | methyl methacrylate | 0.92 | 40 |
| Production Example 3 | PVA-3 | 1,392 | 527 | 0.4 | — | — | 40 |
| Production Example 4 | PVA-4 | 1,392 | 527 | 0.4 | — | — | 40 |
| Production Example 5 | PVA-5 | 1,392 | 527 | 0.4 | — | — | 40 |
| Production Example 6 | PVA-6 | 1,392 | 313 | 0.4 | — | — | 30 |

AIBN: 2,2′-azobisisobutyronitrile
Conversion: conversion of vinyl acetate used

TABLE 2

| | | Saponification | | | | Physical properties of vinyl alcohol polymer | | | |
|---|---|---|---|---|---|---|---|---|---|
| | | | | concentration | | | | viscosity | |
| | | | | of | | | | of 4% | |
| | Type of | | NaOH | saponification | additional | average | | aqueous | |
| | vinyl | | molar | ingredient | NaOH | degree of | degree of | solution at | modification |
| | alcohol | process | ratio | liquid | molar ratio | polymerization | saponification | 20° C. | amount |
| | polymer | — | — | (%) | — | — | (mol %) | (mPa · s) | (mol %) |
| Production Example 1 | PVA-1 | Slurry | 0.008* | 33 | — | 1,400 | >99.9 | 20 | 5.2 |
| Production Example 2 | PVA-2 | Gel | 0.04 | 20 | 0.02 | 1,600 | >99.9 | 28 | 1.8 |
| Production Example 3 | PVA-3 | Gel | 0.04 | 20 | 0.02 | 1,700 | >99.9 | 30 | — |
| Production Example 4 | PVA-4 | Gel | 0.04 | 20 | — | 1,700 | 99.1 | 29 | — |
| Production Example 5 | PVA-5 | Gel | 0.03 | 20 | — | 1,700 | 98.5 | 28 | — |
| Production Example 6 | PVA-6 | Gel | 0.01 | 20 | — | 2,400 | 88.0 | 49 | — |

NaOH molar ratio: molar ratio of sodium hydroxide to vinyl acetate unit in polyvinyl acetate
*molar ratio of sodium methylate

### Example 1

To the vinyl alcohol polymer (PVA-1) was added 10% by mass boric acid powder being capable of passing through a sieve having a mesh opening size of 1 mm, the mesh opening size being defined in JIS Z 8801-1:2019, to produce a mixture, whereby a fluid loss control agent was obtained. The fluid loss control agent thus obtained was evaluated on the swelling percentage and the amount of fluid loss in accordance with the following procedures. The results are shown in Table 3.

### Swelling Percentage

Into a 200 mL beaker was charged 98 g of a saturated aqueous solution of calcium hydroxide, 2 g of the fluid loss control agent was added while stirring at 600 rpm using a magnetic stirrer with hot plate, the mixture was heated to 95° C., and then stirring was performed for an additional 15 min. This mixture was cooled to room temperature, and then a part of a gelatinous matter thus obtained was sampled, and a mass a before drying (g) and a mass b after drying (g) were measured. Separately from this, a solid content percentage c (%) of the fluid loss control agent was measured by a common procedure, and the swelling percentage (%) was calculated in accordance with the following equation.

$$swelling percentage ( \% ) = \{ ( a - b \times 10 \; 0 / c ) / ( b \times 100 / c ) \} \times 100$$

### Production of Cement Slurry

A cement composition was produced by mixing 849.03 g of a class H cement for wells with 6.79 g of the fluid loss control agent. A cement slurry was prepared by charging the cement composition thus obtained, 319.05 g of ion exchanged water, 2.12 g of polycarboxylate ether (“Liquiment 1641F,” available from BASF), 1.78 g of a retardant (“D801,” available from Schlumberger Ltd.), and 1.51 g of a defoaming agent (“D206,” available from Schlumberger Ltd.) into a juice mixer, followed by mixing with stirring in accordance with a procedure disclosed in “API (American Petroleum Institute) RP 10B-2.”

### Amount of Fluid Loss

With respect to the resultant cement slurry, the amount of fluid loss (mL) was determined in accordance with a method described in “API RP 10B-2,” in terms of an amount of fluid loss which occurs in 30 min when the cement slurry, having been adjusted to 190 degrees Fahrenheit, is subjected to a condition involving 1,000 psi of differential pressure. It is to be noted that a smaller amount of fluid loss indicates a superior fluid loss control effect.

### Examples 2 to 7 and Comparative Examples 1 to 4

The swelling percentage of each mixture and the amount of fluid loss of each cement slurry were measured by similar operations to those of Example 1, except that the type of the vinyl alcohol polymer and the type and amount of addition of the crosslinking agent were changed as shown in Table 3. It is to be noted that the amount of addition of the crosslinking agent in Comparative Example 4 was determined in accordance with a procedure disclosed in Table I, Test No. 3 in the specification of U.S. Pat. No. 2,648,645. In the disclosure, 1.0 parts by mass of the vinyl alcohol polymer and 0.02 parts by mass of borax were added with respect to 100 parts by mass of the cement. Furthermore, since 0.12 parts by mass of borax are equivalent to 0.078 parts by mass of boric acid according to TABLE III, 0.013 parts by mass of boric acid, being equivalent to 0.02 parts by mass of borax, in other words, 1.3% by mass boric acid with respect to the vinyl alcohol polymer, were added in this Comparative Example. The results are shown in Table 3. It is to be noted that the amount of addition of each crosslinking agent (% by mass) in Table 3 is a value with respect to the mass of the vinyl alcohol polymer (100% by mass).

TABLE 3

| | Fluid loss control agent | | | | Amount |
|---|---|---|---|---|---|
| | vinyl | crosslinking agent | | swelling | of fluid |
| | alcohol | | amount of addition | percentage | loss |
| | polymer | type | (% by mass) | (%) | (mL) |
| Example 1 | PVA-1 | boric acid | 10 | 3,554 | 84 |
| Example 2 | PVA-1 | boric acid | 15 | 416 | 23 |
| Example 3 | PVA-1 | boric acid | 25 | 507 | 41 |
| Example 4 | PVA-2 | boric acid | 10 | 356 | 39 |
| Example 5 | PVA-3 | boric acid | 2.5 | 205 | 101 |
| Example 6 | PVA-4 | boric acid | 2.4 | 240 | 132 |
| Example 7 | PVA-5 | boric acid | 3.0 | 201 | 169 |
| Comparative Example 1 | PVA-1 | boric acid | 5.0 | 3,769 | 627 |
| Comparative Example 2 | PVA-3 | — | — | dissolved | 666 |
| Comparative Example 3 | PVA-3 | boric acid | 3.0 | 181 | 904 |
| Comparative Example 4 | PVA-6 | boric acid | 1.3 | 5,389 | 873 |

Swelling percentage: 2 g of fluid loss control agent sample charged into 98 g of saturated aqueous solution of calcium hydroxide, stirring performed at 95° C. for 15 min, and then measurement taken
Amount of fluid loss: determined in accordance with API RP 10B-2, Clause 5 at 190 degrees Fahrenheit and differential pressure of 1,000 psi

As is clear from the results of Table 3, the cement slurries produced from the fluid loss control agents (cement compositions) of respective Examples 1 to 7 had low amounts of fluid loss at 190 degrees Fahrenheit and were superior in the fluid loss control effect.

The cement composition containing the fluid loss control agent of Comparative Example 1, having the swelling percentage which exceeded the upper limit of the present disclosure, resulted in the fluid loss control effect being inferior.

With regard to the cement composition containing the fluid loss control agent of Comparative Example 2, which did not contain the crosslinking agent, it was not possible to measure the swelling percentage, and the fluid loss control effect was inferior.

The cement composition containing the fluid loss control agent of Comparative Example 3, having the swelling percentage which was lower than the lower limit of the present disclosure, resulted in the fluid loss control effect being inferior.

With regard to the fluid loss control agent of Comparative Example 4, in which the amounts of addition of the vinyl alcohol polymer and the crosslinking agent were determined in accordance with the procedures disclosed in the specification of U.S. Pat. No. 2,648,645, the swelling percentage exceeded the upper limit of the present disclosure, and the result was such that the fluid loss control effect was inferior.

1. A cement composition comprising a fluid loss control agent and a cement, wherein the fluid loss control agent comprises a vinyl alcohol polymer and a crosslinking agent, and a swelling percentage of the fluid loss control agent is 200% or more and 3,600% or less.

2. The cement composition according to claim 1, wherein the vinyl alcohol polymer and the crosslinking agent are in a powder form.

3. The cement composition according to claim 1, wherein a degree of saponification of the vinyl alcohol polymer is 95 mol % or more.

4. The cement composition according to claim 1, wherein the swelling percentage of the fluid loss control agent is 300% or more and 1,000% or less.

5. The cement composition according to claim 1, wherein
the vinyl alcohol polymer comprises a vinyl alcohol unit and a constituent unit derived from an unsaturated monomer (A),
the unsaturated monomer (A) is at least one selected from the group consisting of an unsaturated carboxylic acid, a salt thereof, an anhydride thereof, and an alkyl ester thereof, and
a content of the constituent unit derived from the unsaturated monomer (A) with respect to total constituent units of the vinyl alcohol polymer is 1.0 mol % or more and 6.0 mol % or less.

6. The cement composition according to claim 1, wherein the unsaturated monomer (A) is at least one selected from the group consisting of methyl acrylate and methyl methacrylate.

7. The cement composition according to claim 1, wherein an average degree of polymerization of the vinyl alcohol polymer is 1,000 or more and 5,000 or less.

8. The cement composition according to claim 1, wherein the vinyl alcohol polymer is a powder which comprises: at a content of 50 to 70% by mass, a particle size fraction consisting of powder particles being capable of passing through a sieve having a mesh opening size of 2.36 mm and being incapable of passing through a sieve having a mesh opening size of 0.15 mm; and at a content of 30 to 50% by mass, a particle size fraction consisting of powder particles being capable of passing through a sieve having a mesh opening size of 0.15 mm, the mesh opening sizes being defined in JIS Z 8801-1:2019.

9. The cement composition according to claim 1, wherein the crosslinking agent is a powder being capable of passing through a sieve having a mesh opening size of 2.36 mm, the mesh opening size being defined in JIS Z 8801-1:2019.

10. The cement composition according to claim 1, wherein the crosslinking agent is capable of forming a pH-sensitive crosslinked structure with the vinyl alcohol polymer.

11. The cement composition according to claim 1, wherein the crosslinking agent is a compound comprising a group 13 element or a group 4 element.

12. The cement composition according to claim 1, wherein the crosslinking agent is a compound comprising boron.

13. The cement composition according to claim 1, wherein the crosslinking agent is at least one selected from the group consisting of boric acid and sodium borate.

14. The cement composition according to claim 1, wherein the crosslinking agent is boric acid.

15. A fluid loss control method for a cement, the fluid loss control method comprising mixing a liquid formulation with the cement composition according to claim 1.

16. A fluid loss control agent comprising a vinyl alcohol polymer and a crosslinking agent, wherein
a swelling percentage of the fluid loss control agent is 200% or more and 3,600% or less.

17. The fluid loss control agent according to claim 16, wherein the vinyl alcohol polymer and the crosslinking agent are in a powder form.

18. A fluid loss control method for a cement, the fluid loss control method comprising mixing a cement with the fluid loss control agent according to claim 16.
